(19) United States
(12) Patent Application Publication
(10) Pub. No.: US 2026/0180164 A1
(43) Pub. Date: Jun. 25, 2026

(54) FEED ASSEMBLY AND ANTENNA

(71) Applicant: HUAWEI TECHNOLOGIES CO., LTD., Shenzhen (CN)

(72) Inventors: Wei Luo, Chengdu (CN); Haibo Fu, Chengdu (CN); Zefeng Chen, Chengdu (CN)

(21) Appl. No.: 19/539,512

(22) Filed: Feb. 13, 2026

Related U.S. Application Data
(63) Continuation of application No. PCT/CN2024/108156, filed on Jul. 29, 2024.

(30) Foreign Application Priority Data
Aug. 15, 2023 (CN) 202311028106.8

(51) Int. Cl. H01Q 1/42; H01P 3/12; H01Q 1/38

(52) U.S. Cl. CPC H01Q 1/42; H01P 3/12; H01Q 1/38

(57) ABSTRACT

This application provides a feed assembly and an antenna. The feed assembly includes a waveguide, a dielectric, and a secondary reflective surface. The waveguide includes a first end and a second end. An inner wall of the waveguide includes one or more ring structures disposed close to the first end. The one or more ring structures are sequentially arranged from the first end to the second end, and an axis of each ring structure extends along an axial direction of the waveguide. One end of the dielectric is inserted into the waveguide from the first end. The secondary reflective surface is fastened to one end of the dielectric away from the waveguide. The feed assembly provided in this application can have good impedance matching performance in a wide frequency band, and therefore antenna bandwidth can be increased.

### CROSS-REFERENCE TO RELATED APPLICATIONS

This application is a continuation of International Application No. PCT/CN2024/108156, filed on Jul. 29, 2024, which claims priority to Chinese Patent Application No. 202311028106.8, filed on Aug. 15, 2023. The disclosures of the aforementioned applications are hereby incorporated by reference in their entireties.

### TECHNICAL FIELD

This application relates to the field of communication technologies, and in particular, to a feed assembly and an antenna.

### BACKGROUND

The rapid development of 5G technologies causes an increase in data traffic of a base station. As one of commonly used methods for data backhaul of the base station, microwave communication faces great challenges. To meet data backhaul requirements of the base station, microwave backhaul links need to have sufficient transmission capacity. Currently, transmission capacity in a microwave communication system is generally enhanced by increasing operating frequency bands. However, increasing the operating frequency bands needs deployment of a plurality of conventional narrowband microwave antennas, which causes a great increase in material costs, installation costs, and tower leasing costs of the system. In view of this, how to increase bandwidth of a microwave antenna is a technical problem to be urgently resolved.

### SUMMARY

This application provides a feed assembly and an antenna, to increase antenna bandwidth.

According to a first aspect, this application provides a feed assembly. The feed assembly may include a waveguide, a dielectric, and a secondary reflective surface. The waveguide includes a first end and a second end that are oppositely arranged along an axial direction. An inner wall of the waveguide includes one or more ring structures disposed close to the first end of the waveguide. The one or more ring structures are sequentially arranged along a direction from the first end to the second end, and an axis of each ring structure extends along the axial direction of the waveguide. The dielectric may be used for impedance matching, one end of the dielectric may be inserted into the waveguide from the first end of the waveguide, and the secondary reflective surface is fastened to one end of the dielectric and away from the waveguide.

In this application, the ring structure of the waveguide may be used for impedance matching. In comparison with solutions in the conventional technology in which impedance matching is implemented only by designing a structure of the dielectric, this application adds an adjustable dimension. In other words, both the waveguide and the dielectric may be used in the feed assembly for impedance matching, so that the feed assembly can have good impedance matching performance in a wide frequency band, and therefore antenna bandwidth can be increased.

In some implementations, the waveguide has a metal inner wall, to facilitate transmission of an electromagnetic wave therein. For example, the waveguide may be made of an all-metal material. In this case, the inner wall of the waveguide is accordingly the metal inner wall. Alternatively, the waveguide may be made of a non-metal material. In this case, metallization processing such as electroplating may be performed on the inner wall of the waveguide, to obtain the metal inner wall.

In some implementation solutions, along the direction from the first end to the second end, an end portion of a first ring structure facing the first end of the waveguide is coplanar with the first end of the waveguide. In other words, a top end of the ring structure closest to the first end of the waveguide is flush with the first end of the waveguide. A position of the ring structure in the waveguide is appropriately designed, helping the waveguide achieve a better impedance matching effect.

In some implementation solutions, there are a plurality of ring structures, and an end portion of at least one ring structure facing the first end may be coplanar with an end portion of an adjacent ring structure facing the second end. In other words, a top end of the at least one ring structure is flush with a bottom end of the adjacent ring structure. Similarly, relative positions of the ring structures are appropriately designed, helping the waveguide achieve a better impedance matching effect.

In some implementation solutions, there are a plurality of ring structures, and at least one ring structure is spaced from an adjacent ring structure. This solution also provides a relative position relationship that can be used for the ring structures, enabling the waveguide to achieve a better impedance matching effect.

In some implementation solutions, there are a plurality of ring structures, and at least two ring structures have a same length. Lengths of the ring structures are appropriately designed, helping the waveguide achieve a better impedance matching effect.

In some implementation solutions, there are a plurality of ring structures, and at least two ring structures have different lengths. This solution also provides a possible design manner of the lengths of the ring structures, enabling the waveguide to achieve a better impedance matching effect.

In some implementation solutions, there are a plurality of ring structures, and the plurality of ring structures have different radial sizes along the waveguide. Radial sizes of the ring structures are appropriately designed, helping the waveguide achieve a better impedance matching effect.

For example, along the direction from the first end to the second end, the radial sizes of the plurality of ring structures may sequentially decrease along the waveguide. Alternatively, along the direction from the first end to the second end, the sizes of the plurality of ring structures may sequentially increase along the waveguide.

In some implementation solutions, there are a plurality of ring structures, and a radial size of at least one ring structure along the waveguide may be larger than radial sizes of two adjacent ring structures along the waveguide; or a radial size of at least one ring structure along the waveguide may be smaller than radial sizes of two adjacent ring structures along the waveguide.

In addition, in the foregoing solution, the two ring structures adjacent to the at least one ring structure may have a same radial size along the waveguide; or the two ring structures adjacent to the at least one ring structure may have different radial sizes along the waveguide.

In some implementation solutions, there are a plurality of ring structures, at least two ring structures have a same radial size along the waveguide, and the two ring structures that have the same radial size along the waveguide are spaced from each other. This solution provides a relative position relationship that can be used for the two ring structures that have the same radial size, enabling the waveguide to achieve a better impedance matching effect.

In some implementation solutions, the one or more ring structures may be ring protrusions. In this case, an inner diameter of the inner wall of the waveguide at a ring structure is smaller than an inner diameter of the waveguide. In some other implementation solutions, the one or more ring structures may be ring grooves. In this case, an inner diameter of the inner wall of the waveguide at a ring structure is larger than an inner diameter of the waveguide. A quantity of ring structures is appropriately designed, helping the waveguide achieve a better impedance matching effect.

According to a second aspect, this application further provides an antenna. The antenna may include a primary reflective surface and the feed assembly in any implementation solution of the first aspect. The second end of the waveguide may run through the primary reflective surface. When the antenna is used to transmit a signal, the waveguide may receive an electromagnetic wave signal generated by a transmitter of a microwave device, and transmit the signal to the secondary reflective surface; and then, the secondary reflective surface reflects the signal to the primary reflective surface; and finally, the primary reflective surface radiates the signal to space. When the antenna is used to receive a signal, electromagnetic waves in space are converged and reflected by the primary reflective surface to the secondary reflective surface; and then, the electromagnetic waves are focused onto the waveguide by the secondary reflective surface; and finally, the electromagnetic waves are transmitted, through the waveguide, to a receiver of a microwave device. The feed assembly can have good impedance matching performance in a wide frequency band, and therefore antenna bandwidth can be increased.

According to a third aspect, this application further provides a microwave device. The microwave device may include a radome and the antenna in the second aspect. The radome has a good electromagnetic wave penetration property in terms of electrical performance, and can withstand impact of a harsh external environment in terms of mechanical performance. Therefore, an adverse impact of the external environment on the antenna can be reduced without affecting signal receiving and sending of the antenna.

### BRIEF DESCRIPTION OF DRAWINGS

FIG. 1 is a diagram of a microwave network architecture according to an embodiment of this application;

FIG. 2 is a diagram of a structure of an antenna according to an embodiment of this application;

FIG. 3 shows a partial structure of a feed assembly according to an embodiment of this application;

FIG. 4 is a diagram of an A-A cross section of the feed assembly shown in FIG. 3;

FIG. 5 is another diagram of an A-A cross section of the feed assembly shown in FIG. 3;

FIG. 6 is another diagram of an A-A cross section of the feed assembly shown in FIG. 3;

FIG. 7 is another diagram of an A-A cross section of the feed assembly shown in FIG. 3;

FIG. 8 is another diagram of an A-A cross section of the feed assembly shown in FIG. 3;

FIG. 9 is another diagram of an A-A cross section of the feed assembly shown in FIG. 3;

FIG. 10 is another diagram of an A-A cross section of the feed assembly shown in FIG. 3;

FIG. 11 is another diagram of an A-A cross section of the feed assembly shown in FIG. 3;

FIG. 12 is another diagram of an A-A cross section of the feed assembly shown in FIG. 3;

FIG. 13 is another diagram of an A-A cross section of the feed assembly shown in FIG. 3; and

FIG. 14 is another diagram of an A-A cross section of the feed assembly shown in FIG. 3.

Reference numerals:
100: Reflector; 110: Primary reflective surface; 120: Through hole;
200: Feed assembly; 210: Waveguide; 210a: First end of the waveguide; 210b: Second end of the waveguide;
211, 211a, 211b, 211c, and 211d: ring structures; 220: Dielectric; 221: Concave area; 230: Mechanical part; and 231: Secondary reflective surface.

### DESCRIPTION OF EMBODIMENTS

To make the objectives, technical solutions, and advantages of this application clearer, the following further describes embodiments of this application in detail with reference to the accompanying drawings. However, example implementations can be implemented in a plurality of forms, and should not be construed as being limited to implementations described herein. Identical reference numerals in the accompanying drawings denote identical or similar structures. Therefore, repeated descriptions thereof are omitted. Words that express positions and directions in embodiments of this application are described by using the accompanying drawings as an example. However, changes may also be made as required, and all the changes fall within the protection scope of this application. The accompanying drawings in embodiments of this application are merely used to illustrate a relative position relationship and do not represent an actual scale.

It should be noted that details are set forth in the following descriptions for ease of understanding this application. However, embodiments of this application can be implemented in a plurality of manners different from those described herein, and a person skilled in the art can perform similar promotion without departing from the connotation of embodiments of this application. Therefore, this application is not limited to the specific implementations disclosed below.

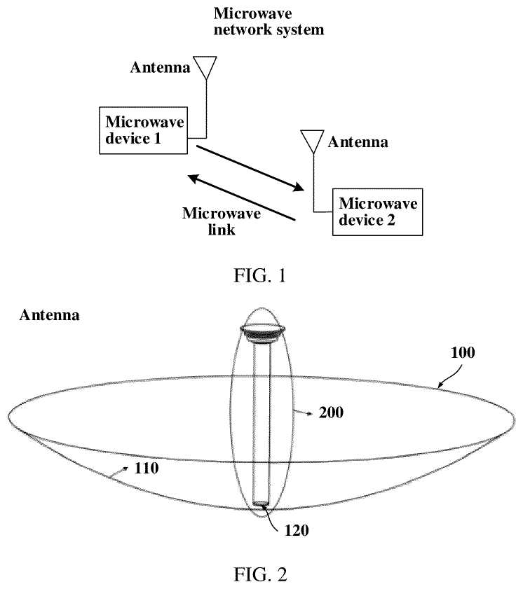

FIG. 1 is a diagram of an example of an architecture of a microwave network system to which an embodiment of this application is applicable. Refer to FIG. 1. The microwave network system may be used for backhaul or fronthaul of a radio signal, and may include two or more microwave devices and a microwave link between any two microwave devices. The microwave devices may communicate with each other via an antenna, and one microwave device may include one or more antennas. The antenna may be mounted on an installation structure. For example, the installation structure may be a pole, a tower, a building, or the like.

In this embodiment of this application, the microwave device may further include modules such as a transmitter and a receiver. For example, a microwave device 1 serves as a transmit end and a microwave device 2 serves as a receive end. An antenna of the microwave device 1 receives a signal sent by a transmitter of the microwave device 1, and sends the signal to an antenna of the microwave device 2 through a microwave link. The antenna of the microwave device 2 further transmits the received signal to a receiver of the microwave device 2.

In addition, the microwave device may further include a radome. The radome has a good electromagnetic wave penetration property, and can withstand impact of a harsh external environment. Therefore, an adverse impact of the external environment on the antenna can be reduced without affecting signal receiving and sending of the antenna.

FIG. 2 is a diagram of a structure of an antenna according to an embodiment of this application. Refer to FIG. 2. In this embodiment of this application, the antenna may include a reflector 100 and a feed assembly 200, and the reflector 100 is fastened to the feed assembly 200. The reflector 100 may be a structure with one concave side and one convex side. A concave surface of the reflector 100 may be used as a primary reflective surface 110 of the antenna, and the primary reflective surface 110 may be used to receive an electromagnetic wave from space or radiate an electromagnetic wave to space. For example, the primary reflective surface 110 may be a paraboloid.

In specific implementation, the primary reflective surface 110 may be a metal surface, for example, an aluminum surface. The reflector 100 may be provided with a through hole 120 that runs through the primary reflective surface 110 to a convex surface of the reflector 100, and an axis of the through hole 120 may approximately coincide with a central axis of the primary reflective surface 110. For example, the reflector 100 may be made of an all-metal material. In this case, the primary reflective surface 110 formed by the concave surface of the reflector 100 is accordingly a metal surface. In another implementation, the reflector 100 may be made of a non-metal material, for example, plastic. In this case, metallization processing such as electroplating may be performed on the concave surface of the reflector 100 to obtain the primary reflective surface 110.

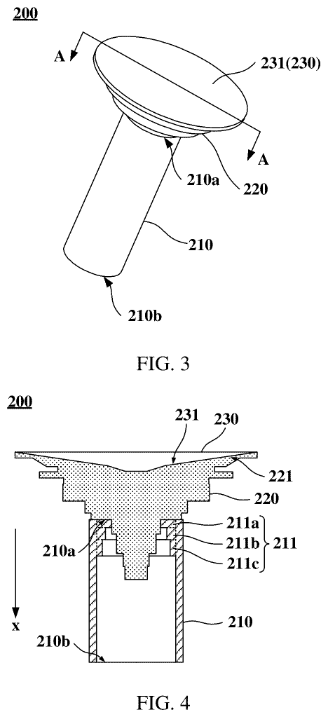

FIG. 3 shows a partial structure of a feed assembly 200 according to an embodiment of this application. Refer to FIG. 2 and FIG. 3 together. The feed assembly 200 may include a waveguide 210, a dielectric 220, and a mechanical part 230 used to provide a secondary reflective surface. The waveguide 210 includes a first end 210a and a second end 210b that are opposite along an axial direction. The first end 210a of the waveguide 210 may be used to mount the dielectric 220. The second end 210b of the waveguide 210 may be inserted into the through hole 120 of the reflector 100 from a side of the primary reflective surface 110, and may extend to a side of the convex surface of the reflector 100. The second end 210b of the waveguide 210 may be used to connect to a transmitter or a receiver. One end of the dielectric 220 is inserted into the waveguide 210 from the first end 210a of the waveguide 210, and another end is exposed outside the waveguide 210. The mechanical part 230 used to provide the secondary reflective surface may be fastened to the end that is of the dielectric 220 and that is exposed outside the waveguide 210.

It can be learned that the dielectric 220 can structurally connect the waveguide 210 and the secondary reflective surface 231, and support the secondary reflective surface 231. In addition, in terms of electrical performance, the dielectric 220 also affects a return loss of the antenna, an amplitude and a phase of an electromagnetic wave, and the like. The dielectric 220 may be made of a dielectric material with a stable dielectric constant and a low loss, for example, polycarbonate (polycarbonate, PC) or polyphenylene oxide (polyphenylene oxide, PPO). The part that is of the dielectric 220 and that is disposed inside the waveguide 210 may be in a shape of a multi-diameter shaft, or may be considered as being formed by stacking a plurality of cylinders or truncated cones with different diameters. Similarly, the part that is of the dielectric 220 and that is exposed outside the waveguide may also be formed by stacking a plurality of cylinders or truncated cones with different diameters. These cylinders or truncated cones may cause the dielectric 220 to have a specific impedance matching function, thereby helping the antenna have a higher gain.

FIG. 4 is a diagram of an A-A cross section of the feed assembly shown in FIG. 3. Refer to FIG. 3 and FIG. 4 together. An end face that is of the dielectric 220 and that is exposed outside the waveguide 210 may have a concave area 221, and a shape of a side of the mechanical part 230 facing the dielectric 220 may be complementary to the concave area 221, so that the mechanical part 230 is attached to the dielectric 220. A surface of the mechanical part 230 attached to the dielectric 220 is the secondary reflective surface 231. The secondary reflective surface 231 may be used to receive an electromagnetic wave from the waveguide 210 and radiate the electromagnetic wave to the primary reflective surface 110, or receive an electromagnetic wave radiated by the primary reflective surface 110 and transmit the electromagnetic wave to the waveguide 210. A shape and a size of the secondary reflective surface 231 are appropriately designed, to adjust spatial distribution of amplitudes and phases of electromagnetic waves reflected by the secondary reflective surface 231.

For example, the mechanical part 230 may be made of an all-metal material, or may be made of a non-metal material. When the mechanical part 230 is made of the non-metal material, metallization processing such as electroplating may be performed on a surface of the mechanical part 230 facing the dielectric 220, to obtain the secondary reflective surface 231.

In this embodiment of this application, when a microwave device serves as a transmit end to transmit a signal, an electromagnetic wave signal generated by a transmitter is transmitted to the secondary reflective surface 231 through the waveguide 210, then reflected by the secondary reflective surface 231 to the primary reflective surface 110, and finally radiated by the primary reflective surface 110 to space. When the microwave device serves as a receive end to receive a signal, an electromagnetic wave in external space is converged and reflected by the primary reflective surface 110 to the secondary reflective surface 231, then focused onto the waveguide 210 by the secondary reflective surface 231, and finally transmitted to a receiver through the waveguide 210.

Still refer to FIG. 4. In this embodiment of this application, the waveguide 210 may have a metal inner wall, to facilitate transmission of the electromagnetic wave between the transmitter/receiver and the secondary reflective surface 231. Similar to the foregoing reflector or the mechanical part 230, in an implementation, the waveguide 210 may be made of an all-metal material, for example, aluminum. In this case, the inner wall of the waveguide 210 is accordingly the metal inner wall. In another implementation, the waveguide 210 may be made of a non-metal material. In this case, metallization processing such as electroplating may be performed on the inner wall of the waveguide 210, to obtain a metal inner wall.

In specific implementation, the inner wall of the waveguide 210 may include a ring structure 211. The ring structure 211 is disposed close to the first end 210a of the waveguide 210, in other words, disposed close to the end of the waveguide 210 connected to the dielectric 220. An axis of the ring structure 211 may extend along the axial direction of the waveguide. For example, the axis of the ring structure 211 may be approximately coaxial with an axis of the waveguide 210. In this embodiment of this application, the ring structure 211 of the waveguide 210 may be used for impedance matching. In comparison with solutions in the conventional technology in which impedance matching is implemented only by designing a structure of the dielectric 220, this embodiment of this application adds an adjustable dimension. In other words, both the waveguide 210 and the dielectric 220 may be used in the feed assembly 200 for impedance matching, so that the feed assembly 200 can have good impedance matching performance in a wide frequency band, and therefore antenna bandwidth can be increased.

In this embodiment of this application, there may be one or more ring structures 211. This is not limited in this application. The plurality of ring structures 211 herein may be two or more ring structures 211, for example, three or four ring structures 211. When there are a plurality of ring structures 211, the plurality of ring structures 211 may be sequentially arranged from the first end 210a of the waveguide 210 to the second end 120b of the waveguide 210. A quantity of the ring structures 211 is appropriately designed, helping the waveguide 210 achieve a better impedance matching effect.

In addition, the ring structure 211 may include a ring protrusion or a ring groove. It is easy to understand that, when the ring structure 211 is the ring protrusion, an inner diameter of the inner wall of the waveguide 210 at the ring structure 211 is smaller than an inner diameter of the waveguide 210; or when the ring structure 211 is the ring groove, an inner diameter of the inner wall of the ring structure 211 at the ring structure is larger than an inner diameter of the waveguide 210. Similarly, a structure form of the ring structure 211 is appropriately designed, enabling the waveguide 210 to achieve a better impedance matching effect.

Still refer to FIG. 4. FIG. 4 shows a case in which the inner wall of the waveguide includes a plurality of ring structures 211. For example, there may be three ring structures 211, and the three ring structures 211 in the figure include ring structures 211a, 211b, and 211c. In this embodiment, the plurality of ring structures 211 may all be ring protrusions. In addition, the plurality of ring structures 211 may have different radial sizes along the waveguide 210. For example, along a direction from the first end 210a of the waveguide 210 to the second end 210b of the waveguide 210, that is, an x direction in FIG. 4, the radial sizes of the plurality of ring structures 211 may sequentially decrease along the waveguide 210. In this case, a difference between radial sizes of any two adjacent ring structures 211 may remain unchanged along the waveguide 210. To be specific, a difference between radial sizes of the ring structure 211a and the ring structure 211b along the waveguide 210 is the same as a difference between radial sizes of the ring structure 211b and the ring structure 211c along the waveguide 210. Certainly, a difference between radial sizes of any two adjacent ring structures 211 may alternatively vary along the waveguide 210.

In some embodiments, at least two ring structures 211 may have a same length, that is, the at least two ring structures 211 may have a same size along the axial direction of the waveguide 210. For example, lengths of the ring structure 211a and the ring structure 211b are the same.

In some embodiments, at least two ring structures 211 may have different lengths. For example, lengths of the ring structure 211b and the ring structure 211c may be different.

Certainly, in some other embodiments, lengths of the plurality of ring structures 211 may be all the same, may be partially the same, or may be different from each other. If the lengths are different from each other, in specific implementation, the lengths of the plurality of ring structures may gradually increase or decrease in a direction, or may increase or decrease at an equal difference; or the sizes may be changed at different differences. These may be designed based on an actual requirement, and details are not described herein again.

Still refer to FIG. 4. Along the direction from the first end 210a of the waveguide 210 to the second end 210b of the waveguide 210, an end portion of a first ring structure 211 (for example, 211a in FIG. 4) facing the first end 210a of the waveguide 210 may be coplanar with the first end 210a of the waveguide 210. In other words, a top end of the ring structure 211a closest to the first end 210a of the waveguide 210 is flush with the first end 210a of the waveguide 210.

In addition, when there are a plurality of ring structures 211, an end portion of at least one ring structure 211 facing the first end 210a of the waveguide 210 may be coplanar with an end portion of an adjacent ring structure 211 facing the second end 210b of the waveguide 210. Alternatively, it may be understood that, along the arrangement direction from the first end 210a of the waveguide 210 to the second end 210b of the waveguide 210, a top end of a ring structure 211 located below is flush with a bottom end of a ring structure 211 located below the ring structure 211. In other words, the plurality of ring structures are seamlessly connected. For example, in the embodiment shown in FIG. 4, a top end of the ring structure 211c may be flush with a bottom end of the ring structure 211b, and a top end of the ring structure 211b is flush with a top end of the ring structure 211a.

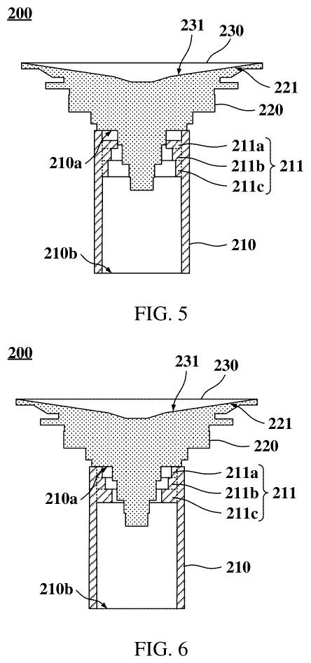

FIG. 5 is another diagram of an A-A cross section of the feed assembly 200 shown in FIG. 3. FIG. 5 shows another case in which the inner wall of the waveguide 210 includes a plurality of ring structures 211. In this embodiment, along a direction from the first end 210a of the waveguide 210 to the second end 210b of the waveguide 210, an end portion of a first ring structure 211 facing the first end 210a of the waveguide 210 may be at a specific spacing with the first end 210a of the waveguide 210. In other words, a top end of the ring structure 211 closest to the first end 210a of the waveguide 210 is non-coplanar with the first end 210a of the waveguide 210. For radial sizes and lengths of the ring structures 211 along the waveguide 210, refer to the embodiment shown in FIG. 4. Details are not described herein again.

FIG. 6 is another diagram of an A-A cross section of the feed assembly 200 shown in FIG. 3. FIG. 6 shows another case in which the inner wall of the waveguide 210 includes a plurality of ring structures 211. In this embodiment, the plurality of ring structures 211 may have different radial sizes along the waveguide 210. Along a direction from the first end 210a of the waveguide 210 to the second end 210b of the waveguide 210, the radial sizes of the plurality of ring structures 211 may sequentially increase along the waveguide 210. Similarly, in this case, a difference between radial sizes of any two adjacent ring structures 211 may remain unchanged along the waveguide 210. To be specific, a difference between radial sizes of a ring structure 211a and a ring structure 211b along the waveguide 210 is the same as a difference between radial sizes of the ring structure 211b and a ring structure 211c along the waveguide 210. Certainly, a difference between radial sizes of any two adjacent ring structures 211 may alternatively vary along the waveguide 210.

In addition, in the embodiment shown in FIG. 6, lengths, disposing positions, and the like of the ring structures 211 in the waveguide 210 may be designed with reference to the embodiment shown in FIG. 4 or FIG. 5. Details are not described herein again.

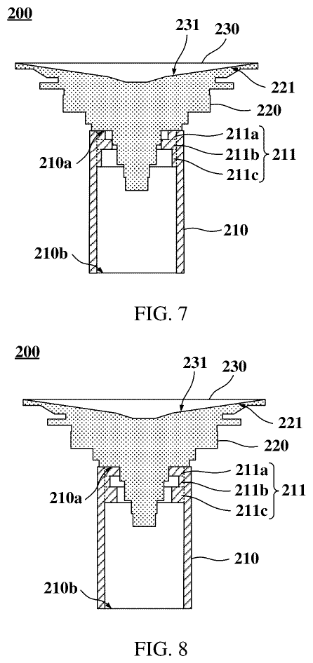

FIG. 7 is another diagram of an A-A cross section of the feed assembly 200 shown in FIG. 3. FIG. 7 shows another case in which the inner wall of the waveguide 210 includes a plurality of ring structures 211. In this embodiment, a radial size of at least one ring structure 211 along the waveguide 210 may be larger than radial sizes of two adjacent ring structures 211 along the waveguide 210. For example, a radial size of a ring structure 211b along the waveguide 210 may be larger than radial sizes of a ring structure 211a and a ring structure 211c along the waveguide 210.

In addition, in the embodiment shown in FIG. 7, lengths, disposing positions, and the like of the ring structures 211 in the waveguide 210 may be designed with reference to the embodiment shown in FIG. 4 or FIG. 5. Details are not described herein again.

FIG. 8 is another diagram of an A-A cross section of the feed assembly 200 shown in FIG. 3. FIG. 8 shows another case in which the inner wall of the waveguide 210 includes a plurality of ring structures 211. In this embodiment, a radial size of at least one ring structure 211 along the waveguide 210 may be smaller than radial sizes of two adjacent ring structures 211 along the waveguide 210. For example, a radial size of a ring structure 211b along the waveguide 210 may be larger than radial sizes of a ring structure 211a and a ring structure 211c along the waveguide 210.

Similarly, in the embodiment shown in FIG. 8, lengths, disposing positions, and the like of the ring structures 211 in the waveguide 210 may be designed with reference to the embodiment shown in FIG. 4 or FIG. 5. Details are not described herein again.

In addition, in the embodiments shown in FIG. 7 and FIG. 8, the radial size of the ring structure 211a along the waveguide 210 may be the same as or different from the radial size of the ring structure 211c along the waveguide 210. In other words, the radial sizes of the two ring structures 211 adjacent to the at least one ring structure 211 along the waveguide 210 may be the same or different. These may be designed based on an actual requirement, and details are not described herein again.

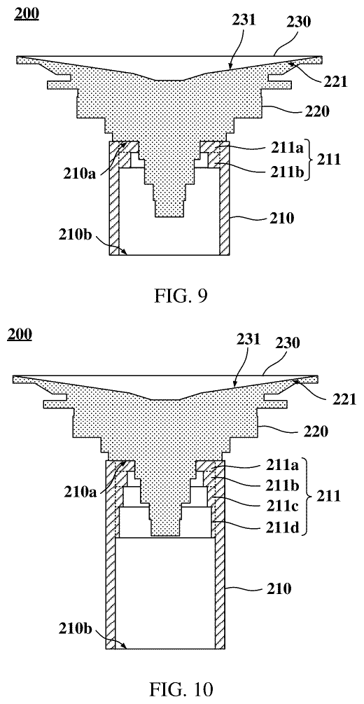

FIG. 9 is another diagram of an A-A cross section of the feed assembly 200 shown in FIG. 3. FIG. 9 shows another case in which the inner wall of the waveguide 210 includes a plurality of ring structures 211. For example, in this embodiment, the inner wall of the waveguide 210 includes two ring structures 211: a ring structure 211a and ring structure 211b. In comparison with the embodiment shown in FIG. 4, in this embodiment, a quantity of the ring structures 211 is decreased. Radial sizes, lengths, disposing positions, and the like of the ring structures 211 in the waveguide 210 may be designed with reference to the embodiments shown in FIG. 4 to FIG. 6. Details are not described herein again.

FIG. 10 is another diagram of an A-A cross section of the feed assembly 200 shown in FIG. 3. FIG. 10 shows another case in which the inner wall of the waveguide 210 includes a plurality of ring structures 211. For example, in this embodiment, the inner wall of the waveguide 210 includes four ring structures 211: a ring structure 211a, a ring structure 211b, a ring structure 211c, and a ring structure 211d. In comparison with the embodiment shown in FIG. 4, in this embodiment, a quantity of the ring structures 211 is increased. Sizes, disposing positions, and the like of the ring structures 211 in the waveguide 210 may be designed with reference to the embodiments shown in FIG. 3 to FIG. 7. Details are not described herein again.

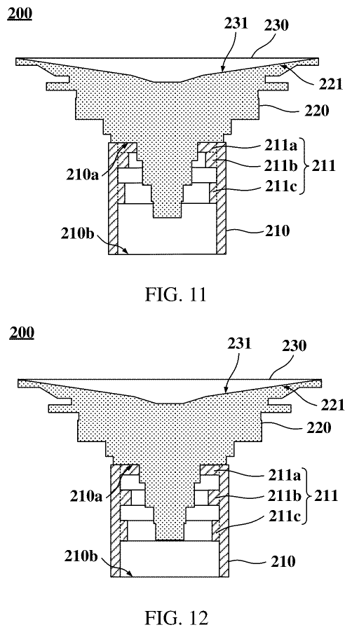

FIG. 11 is another diagram of an A-A cross section of the feed assembly 200 shown in FIG. 3. FIG. 11 shows another case in which the inner wall of the waveguide 210 includes a plurality of ring structures 211. In this embodiment, when there are a plurality of ring structures 211, at least one ring structure 211 is spaced from an adjacent ring structure 211. For example, a ring structure 211c is spaced from a ring structure 211b. In addition, a top end of the ring structure 211b may be flush with a bottom end of a ring structure 211a. In other words, when a quantity of the ring structures 211 is greater than or equal to three, at least one ring structure 211 is spaced from an adjacent ring structure 211, and an end portion of the at least one ring structure 211 facing the first end 210a of the waveguide 210 may be coplanar with an end portion of the adjacent ring structure 211 facing the second end 210b of the waveguide 210.

In the embodiment shown in FIG. 11, sizes, a quantity, disposing positions, and the like of the ring structures 211 in the waveguide 210 may be designed with reference to the embodiments shown in FIG. 4 to FIG. 10. Details are not described herein again. In addition, in this embodiment, radial sizes of the ring structure 211c and the ring structure 211b may be the same or different along the waveguide 210. In other words, when there are a plurality of ring structures 211, at least two ring structures 211 may have a same radial size along the waveguide 210, and the two ring structures 211 having the same radial size along the waveguide 210 are spaced from each other.

FIG. 12 is another diagram of an A-A cross section of the feed assembly 200 shown in FIG. 3. FIG. 12 shows another case in which the inner wall of the waveguide 210 includes a plurality of ring structures 211. In this embodiment, a ring structure 211c is spaced from a ring structure 211b, and the ring structure 211b may also be spaced from a ring structure 211a. In other words, when a quantity of the ring structures 211 is greater than or equal to three, any two adjacent ring structures 211 may be spaced from each other. It may be understood that spacings between a ring structure and adjacent ring structures above and below the ring structure may be the same or different. This is not limited in this application.

In the embodiment shown in FIG. 12, sizes, a quantity, disposing positions, and the like of the ring structures 211 in the waveguide 210 may be designed with reference to the embodiments shown in FIG. 4 to FIG. 10. Details are not described herein again. In addition, in this embodiment, radial sizes of the ring structure 211c and the ring structure 211b may be the same or different along the waveguide 210, and radial sizes of the ring structure 211b and the ring structure 211a may also be the same or different along the waveguide 210. Details may be designed based on an actual requirement, and are not described herein again.

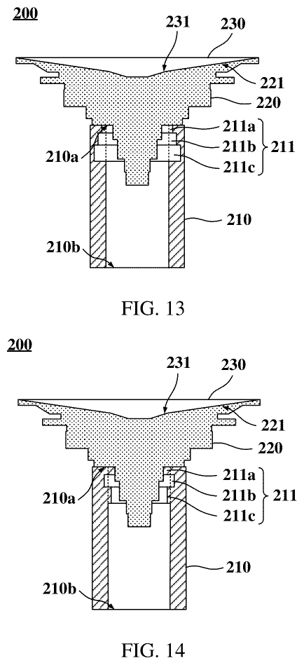

FIG. 13 is another diagram of an A-A cross section of the feed assembly 200 shown in FIG. 3. FIG. 13 shows another case in which the inner wall of the waveguide 210 includes a plurality of ring structures 211. In this embodiment, the plurality of ring structures 211 may all be ring grooves. For a quantity, radial sizes, lengths, an arrangement manner, disposing positions, and the like of the plurality of ring structures 211 in the waveguide 210 may be designed with reference to the embodiments shown in FIG. 4 to FIG. 12. Details are not described herein again. FIG. 13 shows merely an example of a case in which radial sizes of the plurality of ring structures 211 sequentially increase along the waveguide 210. To be specific, depths of a ring structure a, a ring structure b, and a ring structure c sequentially increase.

FIG. 14 is another diagram of an A-A cross section of the feed assembly 200 shown in FIG. 3. FIG. 14 shows another case in which the inner wall of the waveguide 210 includes a plurality of ring structures 211. In this embodiment, the plurality of ring structures 211 may include at least one ring protrusion and at least one ring groove. The three ring structures 211 shown in FIG. 14 include two ring protrusions and one ring groove. For example, a ring protrusion and a ring groove may be alternately disposed along an axial direction of the waveguide 210. Alternatively, the at least one ring protrusion is adjacently disposed in sequence, and the at least one ring groove is adjacently disposed in sequence. In this case, the ring protrusion may be located on a side of the ring groove facing the first end of the waveguide, or may be located on a side of the ring groove facing the second end of the waveguide.

In the embodiment shown in FIG. 14, a quantity, radial sizes, lengths, an arrangement manner, disposing positions, and the like of the plurality of ring structures 211 in the waveguide 210 may be designed with reference to the embodiments shown in FIG. 4 to FIG. 12. Details are not described herein again.

In addition, in any embodiment shown in FIG. 5 to FIG. 14, the dielectric 220 of the feed assembly 200 may use a structure the same as that of the dielectric 220 in the embodiment shown in FIG. 3, or the structure of the dielectric 220 may be modified, for example, a quantity of cylinders in the dielectric 220 is increased or decreased, or a size of a cylinder is changed, so that the feed assembly 200 can have a better impedance matching effect.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A feed assembly, comprising a waveguide, a dielectric, and a secondary reflective surface, wherein
the waveguide comprises a first end and a second end, an inner wall of the waveguide comprises one or more ring structures disposed close to the first end, the one or more ring structures are sequentially arranged from the first end to the second end, and an axis of each ring structure extends along an axial direction of the waveguide;
one end of the dielectric is inserted into the waveguide from the first end; and
the secondary reflective surface is fastened to one end of the dielectric away from the waveguide.

2. The feed assembly according to claim 1, wherein along a direction from the first end to the second end, an end portion of a first ring structure facing the first end is coplanar with the first end.

3. The feed assembly according to claim 1, wherein there are a plurality of ring structures, and an end portion of at least one ring structure facing the first end is coplanar with an end portion of an adjacent ring structure facing the second end.

4. The feed assembly according to claim 1, wherein there are a plurality of ring structures, and at least one ring structure is spaced from an adjacent ring structure.

5. The feed assembly according to claim 1, wherein there are a plurality of ring structures, and at least two ring structures have a same length.

6. The feed assembly according to claim 1, wherein there are a plurality of ring structures, and at least two ring structures have different lengths.

7. The feed assembly according to claim 1, wherein there are a plurality of ring structures, and radial sizes of the plurality of ring structures are different along the waveguide.

8. The feed assembly according to claim 7, wherein along the direction from the first end to the second end, the radial sizes of the plurality of ring structures sequentially decrease along the waveguide.

9. The feed assembly according to claim 7, wherein along the direction from the first end to the second end, the radial sizes of the plurality of ring structures sequentially increase along the waveguide.

10. The feed assembly according to claim 1, wherein there are a plurality of ring structures, and a radial size of at least one ring structure along the waveguide is larger than radial sizes of two adjacent ring structures along the waveguide; or
a radial size of at least one ring structure along the waveguide is smaller than radial sizes of two adjacent ring structures along the waveguide.

11. The feed assembly according to claim 10, wherein the two ring structures adjacent to the at least one ring structure have a same radial size along the waveguide.

12. The feed assembly according to claim 10, wherein the two ring structures adjacent to the at least one ring structure have different radial sizes along the waveguide.

13. The feed assembly according to claim 1, wherein there are a plurality of ring structures, at least two ring structures have a same radial size along the waveguide, and the two ring structures that have the same radial size along the waveguide are spaced from each other.

14. The feed assembly according to claim 1, wherein any one of the one or more ring structures is a ring protrusion or a ring groove.

15. An antenna, comprising a primary reflective surface and the feed assembly according to claim 1, wherein the second end of the waveguide runs through the primary reflective surface.
